(19) United States
(12) Patent Application Publication
(10) Pub. No.: US 2026/0330583 A1
(43) Pub. Date: Oct. 22, 2026

(54) TICKET ISSUING DEVICE, COMPUTER READABLE STORAGE MEDIUM, AND TICKET ISSUING SYSTEM

(71) Applicant: BANDAI CO., LTD., Tokyo (JP)

(72) Inventors: Ryuya WATANABE, Tokyo (JP); Yuki OKABE, Tokyo (JP)

(21) Appl. No.: 19/463,093

(22) Filed: Jan. 29, 2026

(30) Foreign Application Priority Data
Jan. 31, 2025 (JP) 2025-015576

(51) Int. Cl. G06Q 50/34; G06Q 30/0601

(52) U.S. Cl. CPC G06Q 50/34; G06Q 30/0641

(57) ABSTRACT

A ticket issuing device 10 includes: a presentation unit which presents a plurality of lottery tickets; an issuance unit which issues a ticket describing product information; and a control unit which controls the presentation unit and the issuance unit. In addition, the ticket issuing device 10 is capable of presenting, in a distinguishable manner, a selected lottery ticket and an unselected lottery ticket among the lottery tickets which are presented.

The contents of the following patent application(s) are incorporated herein by reference:

NO. 2025-015576 filed in JP on Jan. 31, 2025.

### BACKGROUND

### 1. Technical Field

The present invention relates to a ticket issuing device, a computer readable storage medium, and a ticket issuing system.

### 2. Related Art

Conventionally, as a product provision system in which a consumer can participate in a campaign while having fun, and a burden on a campaign promoter can be reduced while promoting a product, an online lottery-mode product provision system has been proposed (for example, Patent Document 1).

### Related Art Documents

### Patent Document

Patent Document 1: Japanese Patent Application Publication No. 2005-070937

### BRIEF DESCRIPTION OF THE DRAWINGS

FIG. 1 is a front view of a ticket issuing device 10 according to an embodiment.

FIG. 2 is a side view illustrating a state where a door portion 10B of the ticket issuing device 10 is opened.

FIG. 3 is a diagram illustrating an example of a configuration of a ticket issuing system 1.

FIG. 4 is a block diagram illustrating a functional configuration example of the ticket issuing device 10.

FIG. 5 is a diagram illustrating an example of a hardware configuration of a server 30.

FIG. 6 is a diagram illustrating an example of a list 51 of products and inventory displayed on a user terminal 40.

FIG. 7 is a diagram illustrating an example of a product selection screen 52 displayed on a touch panel monitor 12 of the ticket issuing device 10.

FIG. 8 is a diagram illustrating an example of a purchase count selection screen 53 displayed when an option 52A of "dinosaur lottery" is selected.

FIG. 9 is a diagram illustrating an example of a payment screen 54 displayed when an "OK" button 53G is tapped.

FIG. 10 is a diagram illustrating an example of a lottery screen 55 displayed when payment for a purchased lottery is completed.

FIG. 11 is a diagram illustrating an example of an obtained product screen 57 displayed when a lottery option 55B is selected on the lottery screen 55 of FIG. 10.

FIG. 12 is a diagram illustrating an example of a ticket output screen 59 displayed when lottery selection for a purchased count ends.

FIG. 13 is a diagram illustrating an example of a ticket 60 discharged from a thermal printer 13.

FIG. 14 is a diagram illustrating a count-up screen 61 which is an example of a game screen;

### DESCRIPTION OF EXEMPLARY EMBODIMENTS

Hereinafter, aspects of a ticket issuing device, a computer readable storage medium, and a ticket issuing system representing one aspect of the present invention will be described with reference to the drawings.

### Ticket issuing device according to embodiment

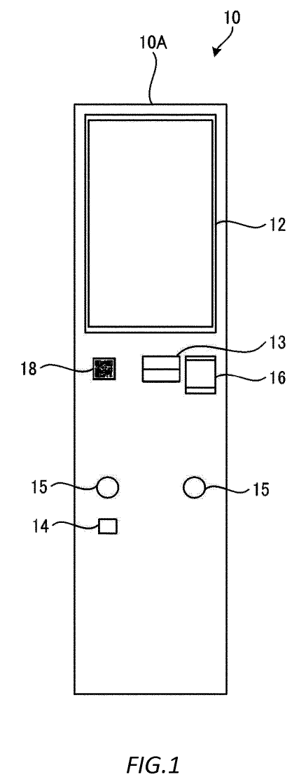

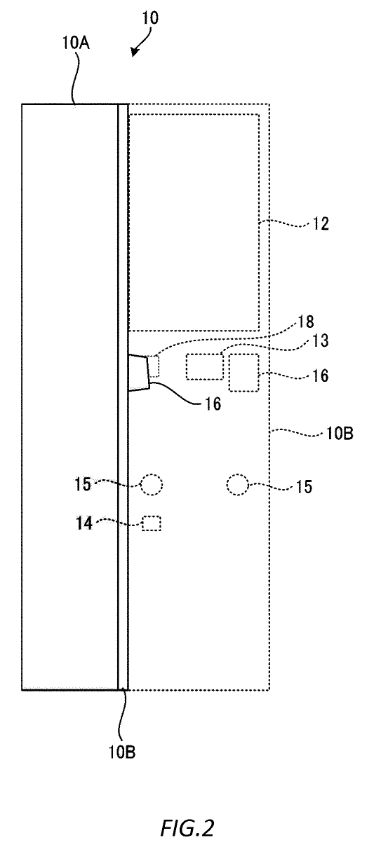

FIG. 1 is a front view of a ticket issuing device 10 according to an embodiment. FIG. 2 is a side view illustrating a state where a door portion 10B of the ticket issuing device 10 is opened.

The ticket issuing device 10 includes, for example, a main body portion 10A which is configured in a box shape, and a door portion 10B which is attached to a front surface side of the main body portion 10A and is openable and closable with one side portion as an axis with respect to the main body portion 10A. In addition, the ticket issuing device 10 includes, in the main body portion 10A, a touch panel monitor 12 which is an example of a “presentation unit”, a “first presentation unit”, an “operation unit”, and a “selection unit” of the present invention, a thermal printer 13 which is an example of an “issuance unit” of the present invention, a code scanner 14, a speaker 15, a payment terminal 16 which is an example of an “acceptance unit” of the present invention, and a seal 18 which is an example of a “second presentation unit” of the present invention.

The ticket issuing device 10 is a device that executes draw processing on a lottery drawn by a user or a game performed by the user, for example, and issues a ticket which is redeemable for a predetermined product. The predetermined product is a product of a plurality of types belonging to a specific title. The specific title is, for example, a product group (a "character series" or the like) including a plurality of characters. Any one character series selected from a plurality of character series is set in the product group. The user can select an arbitrary character series from a plurality of character series prepared in advance, and obtain a product associated with the character series by a lottery method performed by the user themselves or a drawing result of a game method performed by the user themselves.

The seal 18 presents device information with which the ticket issuing device 10 can be identified. The seal 18 presents the device information as, for example, “identification information” in an unchangeable presentation state. The "identification information" is a two-dimensional code indicating a Uniform Resource Identifier (URI) for accessing a World Wide Web (web) page. The identification information is an example of a "second aspect" of the present invention.

### Ticket issuing system according to embodiment

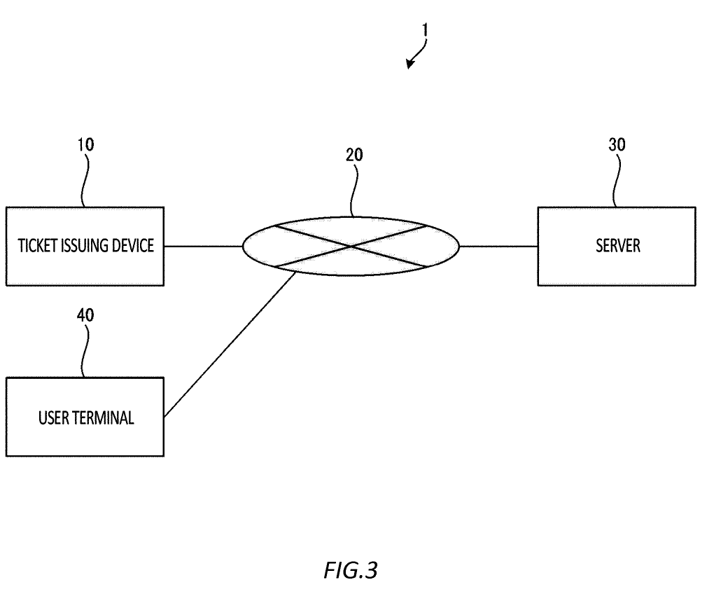

FIG. 3 is a diagram illustrating an example of a configuration of a ticket issuing system 1. As illustrated in FIG. 3, the ticket issuing system 1 includes the ticket issuing device 10, a server 30, and a user terminal 40. The ticket issuing device 10, the server 30, and the user terminal 40 are communicably connected to each other via a network 20. The server 30 is an example of a "management device" of the present invention.

The ticket issuing device 10 acquires a plurality of pieces of product information providable to the user, from the server 30 via the network 20. The server 30 can manage sales of a product for each ticket issuing device, based on the product information transmitted to and received from the ticket issuing device.

The user terminal 40 acquires the device information regarding the ticket issuing device 10, from the server 30 via the network 20. The server 30 can grasp user trends based on the information, regarding the ticket issuing device 10, transmitted to and received from the user terminal 40.

The user terminal 40 can acquire, for example, the identification information presented by the seal 18 affixed to the ticket issuing device 10. The identification information is configured to be different for each ticket issuing device 10. In addition, the identification information is configured to be acquirable by the user terminal 40 before acceptance of payment of consideration.

On condition that it is acquired by the user terminal 40, the identification information enables inventory information on products for the ticket issuing device 10 to be presented to the user terminal 40. The inventory information is configured to be presented by reading the identification information (two-dimensional code) with a camera and accessing a URI indicated by the two-dimensional code with a web browser.

The identification information is configured to be valid in a state where the ticket issuing device 10 is powered on. When the ticket issuing device 10 is powered on and the ticket issuing device 10 is in a communicable state (online) with the server 30, the server 30 allows a web page of the inventory information to be browsed in response to a request for the URI of the two-dimensional code. The identification information is configured such that, in a state where the ticket issuing device 10 is powered on, the inventory information on products for the ticket issuing device 10 is able to be presented to the user terminal 40.

The identification information is configured such that the inventory information on products for the ticket issuing device 10 as of the time of acquisition of the identification information by the user terminal 40 is able to be presented to the user terminal 40 only for a certain period of time. The inventory information becomes hidden on a display screen of the user terminal 40, for example, after the certain period of time has elapsed since its display on the user terminal 40. In addition, the inventory information may be updated to latest inventory information after the certain period of time has elapsed since its display on the user terminal 40.

### Functional configuration of ticket issuing device

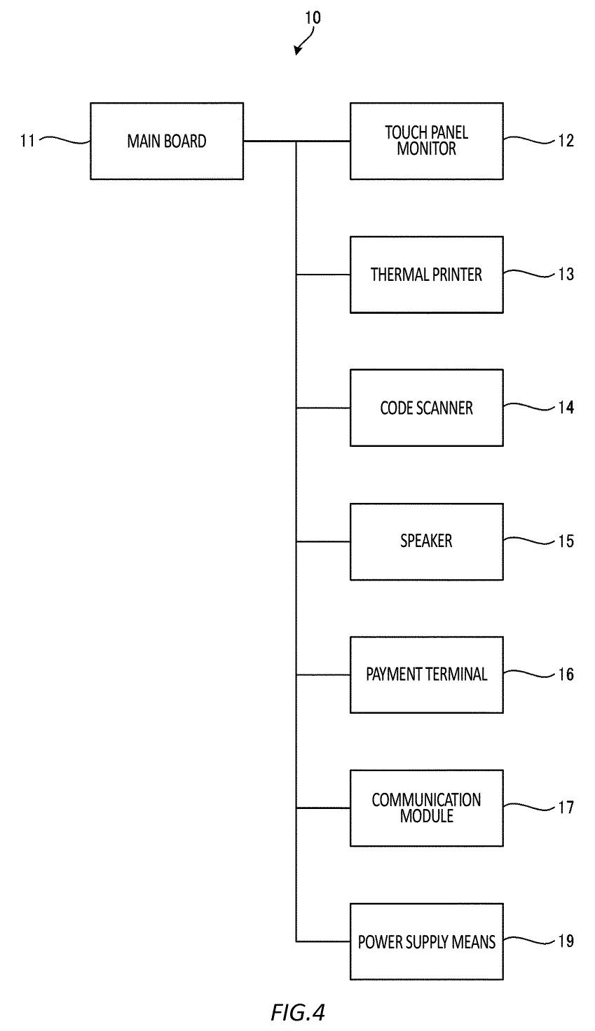

FIG. 4 is a block diagram illustrating a functional configuration example of the ticket issuing device 10. As illustrated in FIG. 4, the ticket issuing device 10 is provided with a main board 11, a communication module 17, and a power supply means 19 in addition to the touch panel monitor 12, the thermal printer 13, the code scanner 14, the speaker 15, and the payment terminal 16. The touch panel monitor 12, the thermal printer 13, the code scanner 14, the speaker 15, the payment terminal 16, the communication module 17, and the power supply means 19 are electrically connected to the main board 11. The main board 11 controls an operation of each connected unit.

The main board 11 is an example of a "control unit" of the present invention. The code scanner 14 and the main board 11 are examples of a “registration unit” of the present invention. The communication module 17 and the main board 11 are examples of an "acquisition unit" of the present invention. The communication module 17 and the main board 11 are examples of a "transmission unit" of the present invention. A central processing unit (CPU) is mounted on the main board 11. The CPU of the main board 11 controls each unit based on a ticket issuing program stored in a storage unit (not illustrated) to perform each control such as ticket issuance.

The touch panel monitor (presentation unit) 12 presents a lottery provision image for a sales method based on the lottery method performed by the user and a game provision image for a sales method based on the game method performed by the user. The lottery method is an example of a "first provision mode" of the present invention. The game method is an example of a "second provision mode" of the present invention. The touch panel monitor 12 presents the lottery method or the game method such that either thereof can be selected. The provision mode (lottery method or game method) is preset for each product group. When an arbitrary product group is selected from a plurality of product groups by the user, a provision mode set for the product group is selected by the main board 11 of the ticket issuing device 10. The touch panel monitor 12 presents the selected provision method.

Different pieces of product information are associated with the lottery method and the game method, respectively. A first type of product is associated with the lottery method. A second type of product different from the first type is associated with the game method. In addition, a first type of product group is associated with the lottery method. A second type of product group is associated with the game method.

In the lottery method and the game method, a lottery ticket selectable by the user is randomly associated with any piece of prize grade information among a plurality of pieces of prize grade information. In order to select a lottery ticket in a provision image, a touch operation on the presented lottery ticket for a certain period of time or longer (for example, one second or longer) is required as a condition. An operation of simultaneously selecting two or more lottery tickets among a plurality of lottery tickets in the provision image is invalidated.

The lottery method is a provision mode based on random drawing performed by the user. The game method is a provision mode based on play content of a game performed by the user. The game method is a provision mode based on play content of the user in any one game selected from a plurality of games.

When the lottery method is selected, an operation count of the touch panel monitor (operation unit) 12 is smaller than when the game method is selected. That is, when obtaining a product, the user can obtain the product with a smaller operation count in the lottery method than in the game method. In addition, when the lottery method is selected, a period of time until issuance is shorter than when the game method is selected. That is, when obtaining a product, the user can obtain the product in a shorter period of time in the lottery method than in the game method.

The touch panel monitor 12 presents product information regarding a product that can be provided to the user. The product information regarding the product that can be provided to the user is product information registered on the main board 11.

The touch panel monitor 12 presents a plurality of lottery tickets that can be drawn by the user’ selection in the lottery provision image and the game provision image. The touch panel monitor 12 presents the lottery tickets as, for example, “patterns” in a changeable presentation state. The patterns are an example of a "first aspect" of the present invention. The first aspect is an aspect different from a second aspect ("identification information").

The touch panel monitor 12 can present, in a distinguishable manner, a selected lottery ticket and an unselected lottery ticket among the presented lottery tickets. The selected lottery ticket includes the product information, the prize grade information, and the like which are visually recognizable. The unselected lottery ticket does not include the product information, the prize grade information, and the like which are visually recognizable. The selected lottery ticket is displayed in a manner that allows the product obtained by the user, its prize grade, and the like to be recognizable. The unselected lottery ticket is displayed in a manner that does not allow an obtainable product, its prize grade, and the like to be recognizable.

The touch panel monitor 12 can present, in a distinguishable manner, a lottery ticket selected by oneself and a lottery ticket selected by another person among the selected lottery tickets. Specifically, the touch panel monitor 12 presents, in a distinguishable manner, a lottery ticket selected in a current ticket issuance procedure and a lottery ticket that has been selected in a past ticket issuance procedure. In addition, the touch panel monitor 12 can present all unselected lottery tickets among the plurality of lottery tickets in a visually recognizable manner with a same pattern. In other words, the unselected lottery tickets are displayed such that the user cannot distinguish them only by looking at the lottery tickets. In addition, on condition that a lottery ticket has been selected, the touch panel monitor 12 can present at least one of the product information and the prize grade information corresponding to the selected lottery ticket.

The touch panel monitor 12 can present a plurality of lottery tickets at fixed positions in the provision image. For example, the touch panel monitor 12 can present the plurality of lottery tickets in a matrix form.

The touch panel monitor 12 can present lottery tickets corresponding to the inventory information on products. The inventory information on products can be acquired from the server 30 via the communication module 17 by the main board 11. "Inventory" refers to inventory at a nearby exchange center or inventory in a delivery warehouse. The touch panel monitor 12 presents, in a selectable manner, lottery tickets corresponding to product information of products with available inventory, and presents, in an unselectable manner, lottery tickets corresponding to product information of products with no available inventory. The touch panel monitor 12 presents, as having been selected, the lottery tickets corresponding to the product information of the products with no available inventory. The touch panel monitor 12 can present the lottery tickets on condition that the inventory information on products is acquired. Note that the lottery ticket does not present the inventory information on the product of the product information.

The touch panel monitor (first presentation unit) 12 can present a plurality of lottery tickets after acquisition of the identification information by the user terminal 40. For example, the touch panel monitor 12 presents the plurality of lottery tickets when a user terminal 40 (the user terminal may be anyone's user terminal) has accessed a web page of the inventory information within a certain period of time in the past. In addition, as a configuration for selling a product after authenticating an accessing user, the touch panel monitor 12 may present the plurality of lottery tickets when the web page of the inventory information has been accessed by the user terminal 40 of that user. After acquisition of the identification information by the user terminal 40, the touch panel monitor 12 presents the plurality of lottery tickets such that any lottery ticket among the plurality of presented lottery tickets can be selected.

The touch panel monitor (selection unit) 12 enables selection of a method of receiving the product of the product information corresponding to the lottery ticket. The touch panel monitor 12 presents, as receiving methods, for example, an "exchange-receiving method" of exchanging a printed ticket and a product and a "delivery-receiving method" of receiving a product by online shipping, and allows a user to select a receiving method from among them by a selection operation (touch operation). The exchange-receiving method is a method in which the user receives the product without the delivery of the product. The delivery-receiving method is a method in which the user receives the product via the delivery of the product. The exchange-receiving method is an example of a "first receiving method" of the present invention. The delivery-receiving method is an example of a “second receiving method” of the present invention.

When the delivery-receiving method is selected, the touch panel monitor (presentation unit) 12 displays the identification information on the monitor. The "identification information" is, for example, a two-dimensional code. The identification information is configured such that recipient information is able to be input after acquisition by the user terminal 40. The “recipient information” is an address, a name, a delivery date, and the like of a delivery destination. The method of receiving the product can be selected either before the selection of the lottery ticket or after the selection of the lottery ticket.

The touch panel monitor 12 can simultaneously present the exchange-receiving method and the delivery-receiving method. When ticket issuance is unavailable, the touch panel monitor 12 enables selection of only the delivery-receiving method. “Ticket issuance is unavailable” refers to malfunctions of the thermal printer (for example, out of paper, out of toner, or a failure). When product delivery is unavailable, the touch panel monitor 12 enables selection of only the exchange-receiving method. “Product delivery is unavailable” refers to a case where the ticket issuing device 10 is set to a product delivery-unavailable state. For example, the setting may be configured by communication from the server 30 or may be configured by an operation on the ticket issuing device 10. Specifically, the setting of the product delivery-unavailable state is configured at the time of disaster or the like.

The touch panel monitor 12 enables selection of the receiving method after acceptance of payment of consideration via the payment terminal 16. The touch panel monitor 12 enables selection of the lottery ticket after the acceptance of the payment of consideration.

The thermal printer (issuance unit) 13 issues a ticket describing any piece of product information selected from a plurality of pieces of product information registered on the main board 11. The ticket is configured as a paper medium. The issued ticket is redeemable for a product. The ticket includes a "receipt" describing sales information and a "voucher" redeemable for an actual product. In the receipt, for example, a store name, a store address, a store telephone number, a purchase date, payment information, and the like are described. In the voucher, for example, a product title, a store name, a store address, a store telephone number, a purchase date, a product name, details of prizes to be received, and the like are described. The receipt and the voucher are discharged in a separable manner at the time of discharge (at the time of issuance). At the time of product exchange, only the voucher is collected.

The thermal printer 13 can issue a ticket describing the product information corresponding to any of the lottery method or the game method. When the lottery method is selected, the thermal printer 13 can issue a ticket describing any one piece of product information selected from the first type of product group. In addition, when the game method is selected, the thermal printer 13 can issue a ticket describing any one piece of product information selected from the second type product group.

The thermal printer 13 can issue a ticket describing, as the product information, the prize grade information (for example, Prize A, Prize B, and the like) selected based on a result of random drawing (lottery) or a result of game play content by the user.

As for a selection count of the lottery tickets in the lottery method and the game method, a plurality of selections are possible in a series of ticket issuance procedures. When the user selects a lottery ticket a plurality of times in the lottery method and the game method, the thermal printer 13 can issue a ticket describing a plurality of pieces of prize grade information selected from the drawing results.

The thermal printer 13 can issue a ticket describing prize grade information selected from the product information registered in the main board 11. As the product information, a plurality of pieces of prize grade information are included for each character series.

The thermal printer 13 can issue a lottery ticket on condition that the main board 11 acquires the inventory information on products from the server 30.

The thermal printer 13 does not issue a lottery ticket when a number of at least one lottery ticket, among a plurality of lottery tickets, corresponding to the product information of the products with available inventory becomes equal to or less than a certain number. When a remaining count of at least one lottery ticket corresponding to a certain product becomes equal to or less than a certain value, the thermal printer 13 stops a service in the ticket issuing device 10 even if the product has available inventory. For example, in a state where the remaining count of at least one lottery ticket is small and no one selects the lottery ticket, a state where only products with a low prize grade remain, or the like, the sale of the lottery ticket is stopped.

The thermal printer 13 can issue a lottery ticket after acquisition of the identification information by the user terminal 40.

The thermal printer 13 can set an upper limit of the selection count of the lottery tickets in a series of ticket issuance procedures. The "series of ticket issuance procedures" refers to selection and payment for a lottery ticket. The "selection count" refers to a purchase count. The "upper limit of the selection count" is an upper limit of a selection count in a series of ticket issuance procedures. The upper limit of the selection count of the lottery tickets can be set by an administrator of the ticket issuing device 10. The upper limit of the selection count of the lottery tickets cannot be set by the user of the ticket issuing device 10. The upper limit of the selection count of the lottery tickets can be set based on any operation of a direct operation or an indirect operation on the ticket issuing device 10. The indirect operation is an operation from the server 30 which is a management device of the ticket issuing device 10. When the selection count of the lottery tickets reaches the set upper limit count, a new selection is not available for the lottery tickets. The user which has selected up to the upper limit count ends the series of ticket issuance procedures of that turn (order) and then, passes the turn to a next user. When the selection count of the lottery tickets has reached the upper limit, the lottery tickets can be selected by performing a new series of ticket issuance procedures.

The upper limit of the selection count of the lottery tickets can be set for each product group. In addition, the upper limit of the selection count of the lottery tickets can be set for each character series. A desired lottery ticket selection count to be selected by the user can be selected before the selection of the lottery tickets. The desired selection count can be selected within the upper limit of the selection count. The lottery ticket can be selected for a count corresponding to the desired lottery ticket selection count that has been selected.

The thermal printer 13 can issue a ticket describing product information corresponding to the selected lottery ticket. The thermal printer 13 may describe, for example, the selection count of the lottery tickets, the method of receiving a product, and the like in the issued ticket.

The thermal printer 13 enables a ticket to be issued when the exchange-receiving method is selected. For example, the thermal printer 13 issues a voucher of a ticket (receipt and voucher) when the exchange-receiving method is selected as the method of receiving the product, and does not issue the voucher when the delivery-receiving method is selected. In addition, the thermal printer 13 may issue the receipt of the ticket when the exchange-receiving method is selected and not issue the receipt, similarly to the voucher, when the delivery-receiving method is selected, or may issue the receipt regardless of whether the exchange-receiving method or the delivery-receiving method is selected.

The thermal printer 13 includes a printing unit capable of printing product information and the like on a paper medium. The thermal printer 13 is configured such that a business operator involved in providing a ticket can access the thermal printer 13 by opening the door portion 10B of the main body portion 10A toward a front (a state of FIG. 2). In addition, the printing unit of the thermal printer 13 is configured such that ticket paper can be replenished by opening the door portion 10B.

Any of the user or the administrator of the ticket issuing device 10 can select the provision mode (the lottery method and the game method) for each product group presented at the time of ticket issuance. Note that, as for the selection of the lottery method and the game method, the user may make the selection by operating the touch panel monitor 12, or the administrator may make the selection so that the user is not allowed to make the selection.

In addition, the provision mode for each product group presented at the time of ticket issuance is configured to be changeable depending on a period. For example, since the product group to be provided is changed depending on the period, the provision mode corresponding to the product group also changes accordingly.

The code scanner 14 reads a code including a plurality of pieces of product information providable to the user. The code includes information (request destination) for acquiring the "plurality of pieces of product information" from the server 30. The “plurality of pieces of product information” are character series information including a plurality of characters. The code scanner 14 is provided on an outer surface of the main body portion 10A, and is configured to be able to read a code regarding a replenishment product supplied by a business operator without opening the door portion 10B.

The speaker 15 can output, by voice, information regarding ticket issuance by the ticket issuing device 10. For example, it is possible to provide voice guidance to the user concerning information regarding an operation of ticket issuance. Specifically, an operation procedure or the like regarding a lottery drawn by the user or a game performed by the user is guided by voice.

The payment terminal (acceptance unit) 16 can accept the payment of consideration for the ticket issuance. The payment terminal 16 can accept consideration before or after any of the lottery method or the game method is selected via the touch panel monitor 12. The payment terminal 16 can perform, for example, payment by card or payment by code. Note that a coin payment module consisting of, for example, a coin selector, a cash box, or the like may be provided so that payment by cash is possible.

In the provision of the lottery method and the game method, the payment terminal 16 can accept payment of the consideration before selection of the lottery ticket. The selection of the lottery ticket is configured to be made after the payment of the consideration is completed. In addition, when accepting consideration for two or more lottery tickets among a plurality of lottery tickets, the payment terminal 16 enables selection of two or more lottery tickets.

In the provision of the lottery method and the game method, the payment terminal 16 can accept the consideration on condition that inventory is available for the product of the product information included in at least one of the lottery tickets. For example, even if the lottery ticket for selection still remains, the payment terminal 16 does not accept the consideration when there is no inventory available for the product and the product cannot be provided.

The payment terminal 16 can accept the payment of the consideration after acquisition of the identification information by the user terminal 40. Assuming that the display of the inventory information and the payment are executed by a dedicated application, the payment terminal 16 is configured such that the payment is not possible until after the inventory information has been displayed.

The payment terminal 16 can accept the payment of the consideration after the desired lottery ticket selection count has been selected. The payment terminal 16 accepts the payment of the consideration after the selection count of the lottery tickets is determined.

When the delivery-receiving method is selected, the payment terminal 16 can accept payment of further consideration. The "consideration" refers to a shipping cost of the product. When the delivery-receiving method is selected, the lottery ticket can be selected after the payment including the shipping cost is made. The payment terminal 16 enables delivery of the product on condition that the payment of further consideration is accepted. When the exchange-receiving method is selected as the receiving method, a period until the product is received is a first period. When the delivery-receiving method is selected, a period until the product is received is a second period longer than the first period. In the exchange-receiving method, the product can be received earlier than in the delivery-receiving method.

The communication module 17 is a module capable of communicating with an external server 30 that is a supply source of the product information. The communication module 17 is, for example, an LTE terminal capable of performing communication by long term evolution (LTE).

The power supply means 19 supplies power to each unit of the ticket issuing device 10.

The main board 11 registers a plurality of pieces of product information providable to the user. The main board 11 can register all product information of a character series indicated by the code read by the code scanner 14. The character series includes a plurality of pieces of product information providable to the user for each character series. The main board 11 can register the plurality of pieces of product information included in the character series and providable to the user by reading the code indicating the character series together with the code scanner 14.

The main board 11 manages the inventory of products, based on the inventory information on products acquired from the server 30. The main board 11 (acquisition unit) can acquire the inventory information from the server 30 on condition that the inventory of products has changed from a state of having no available inventory to a state of having available inventory. For example, when the product is stocked and the inventory of products changes from the state of no inventory to the state of having inventory, the server 30 transmits updated inventory information to the ticket issuing device 10. The main board 11 can acquire the inventory information on products from the server 30 on condition that the power supply means 19 is turned on. The main board 11 acquires the inventory information when power is turned on, and thereafter, acquires the inventory information periodically or when the inventory information changes.

Every time a lottery ticket is issued, the main board 11 (transmission unit) can transmit issuance information regarding the lottery ticket to the server 30 via the communication module 17 .

### Hardware configuration of server

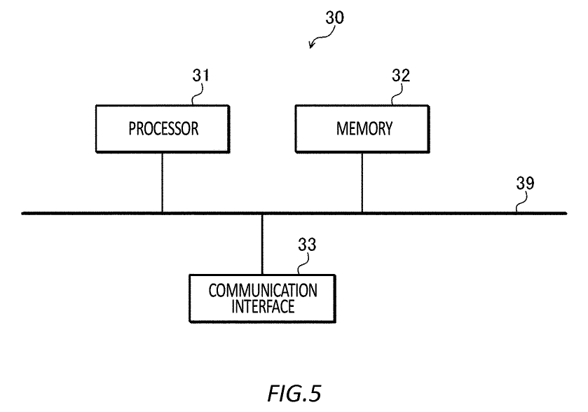

FIG. 5 is a diagram illustrating an example of a hardware configuration of the server 30. As illustrated in FIG. 5, the server 30 includes a processor 31, a memory 32, and a communication interface 33. The processor 31, the memory 32, and the communication interface 33 are connected by, for example, a bus 39.

The processor 31 is a circuit which performs signal processing, and is, for example, a central processing unit (CPU) that controls the entire server 30. Note that the processor 31 may be implemented by another digital circuit such as a field programmable gate array (FPGA) or a digital signal processor (DSP). In addition, the processor 31 may be implemented by combining a plurality of digital circuits.

The memory 32 includes, for example, a main memory and an auxiliary memory. The main memory is, for example, a random access memory (RAM). The main memory is used as a work area of the processor 31.

The auxiliary memory is, for example, a nonvolatile memory such as a magnetic disk, an optical disk, or a flash memory. The auxiliary memory stores various management programs for operating the server 30. The programs stored in the auxiliary memory are loaded into the main memory and executed by the processor 31.

In addition, the auxiliary memory may include a portable memory removable from the server 30. Examples of the portable memory include a universal serial bus (USB) flash drive or a memory card such as a secure digital (SD) memory card, an external hard disk drive, and the like.

The communication interface 33 is a communication interface that communicates with an outside (for example, the network 20) of the server 30. The communication interface 33 is controlled by the processor 31.

The processor 31 and the communication interface 33 manage product sales for each ticket issuing device 10, based on the product information transmitted to and received from the ticket issuing device 10. In addition, the processor 31 and the communication interface 33 grasp user trend based on the information, regarding the ticket issuing device 10, transmitted to and received from the user terminal 40.

### Ticket issuance operation of ticket issuing device

Hereinafter, a ticket issuance operation by the ticket issuing device 10 will be described.

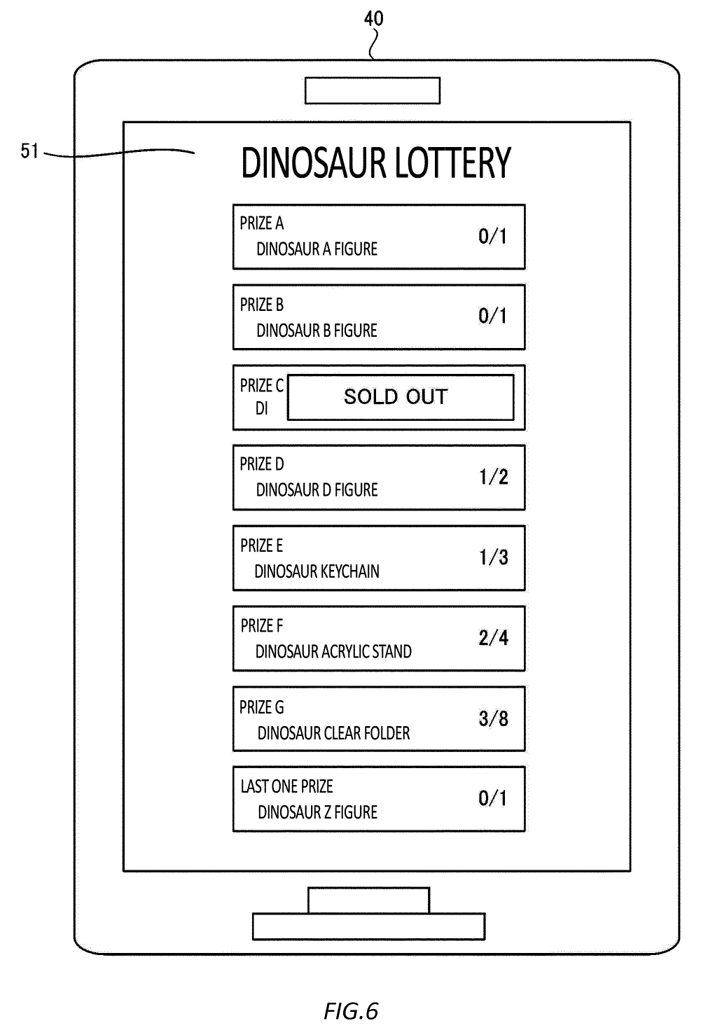

FIG. 6 is a diagram illustrating an example of a list 51 of products and inventory displayed on the user terminal 40. The list 51 of products and inventory can be displayed by reading a two-dimensional code of the seal 18 affixed to the ticket issuing device 10 with the user terminal 40. When the two-dimensional code is read by a camera of the user terminal 40, it is possible to access a web page indicating inventory information of the ticket issuing device 10, and the inventory information is presented on the display screen of the user terminal 40.

In the list 51 of products and inventory, types of obtainable products (characters) and a remaining count of at least one product are displayed. In the list 51 of products and inventory illustrated in FIG. 6, Prize A: Dinosaur A figure, Prize B: Dinosaur B figure, Prize C: Dinosaur C figure, Prize D: Dinosaur D figure, Prize E: dinosaur keychain, Prize F: dinosaur acrylic stand, Prize G: dinosaur clear folder, and Last one prize: Dinosaur Z figure are displayed as types of characters in a dinosaur lottery (product group). In addition, the remaining count of at least one product is displayed as, for example, 0/1= (count of prizes already selected)/(count of each prize included). For products that are no longer remaining, SOLD OUT is displayed.

Note that the product group displayed on the user terminal 40 can be changed to another product group by swiping the display screen of the user terminal 40, for example. The user can confirm the inventory information on products for the ticket issuing device 10 and then determine whether or not to issue a ticket with the ticket issuing device 10.

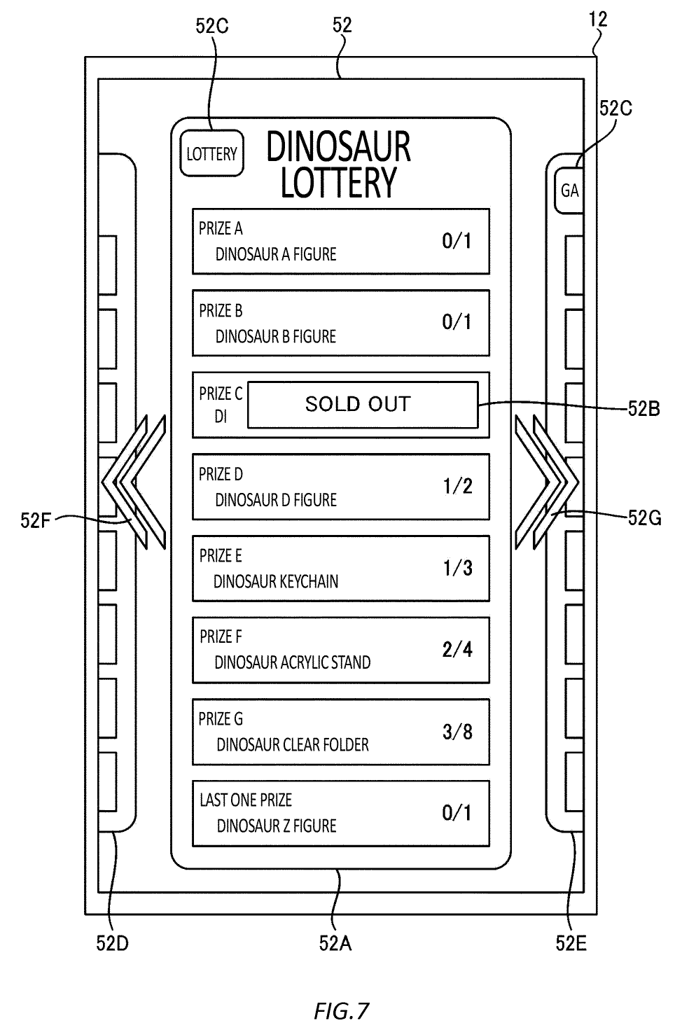

FIG. 7 is a diagram illustrating an example of a product selection screen 52 displayed on the touch panel monitor 12 of the ticket issuing device 10. In a case of issuing a ticket, for example, when an "issuance start button" (not illustrated) displayed on the touch panel monitor 12 is tapped, the screen transitions to a product selection screen 52 illustrated in FIG. 7.

On the product selection screen 52, title options prepared to be selectable are displayed. On the product selection screen 52 illustrated in FIG. 7, an option 52A of "dinosaur lottery" is displayed as an option. In the option 52A of "dinosaur lottery", "dinosaur lottery" indicating a product group (character series) and product information of a plurality of characters included in the product group are displayed. The plurality of characters are product information registered in the main board 11. Specifically, in the options 52A of “dinosaur lottery”, the Dinosaur A figure, the Dinosaur B figure, the Dinosaur C figure, the Dinosaur D figure, the dinosaur keychain, the dinosaur acrylic stand, the dinosaur clear folder, the Dinosaur Z figure, and prize grades (Prizes A to G, last one prize) associated with these products are displayed. In addition, for example, a "SOLD OUT" label 52B is displayed in a prize grade for which there is no inventory providable for the product. In addition, for example, "1/3" for the dinosaur keychain of Prize E represents that dinosaur lotteries include three pieces of Prize E, and one among the three pieces is selected, so that two pieces remain. In the option 52A of "dinosaur lottery", a provision method 52C associated with the dinosaur lottery is displayed. The provision method 52C of the dinosaur lottery is set to the "lottery method".

As selectable title options, options 52D and 52E of other lotteries and the like are prepared in addition to the option 52A of the "dinosaur lottery". When it is desired to draw lotteries for these options 52D and 52E, for example, a scroll button 52F is tapped to move the option 52D on the left to the center of the product selection screen 52, or the scroll button 52G is tapped to move the option 52E on the right to the center of the product selection screen 52. By tapping an option displayed at the center, its title ("dinosaur lottery" in a case of this example) is selected. Note that the provision method 52C of the “game method” is set as the option 52E. In addition, a product image may be displayed in each option in addition to the product information and the prize grade.

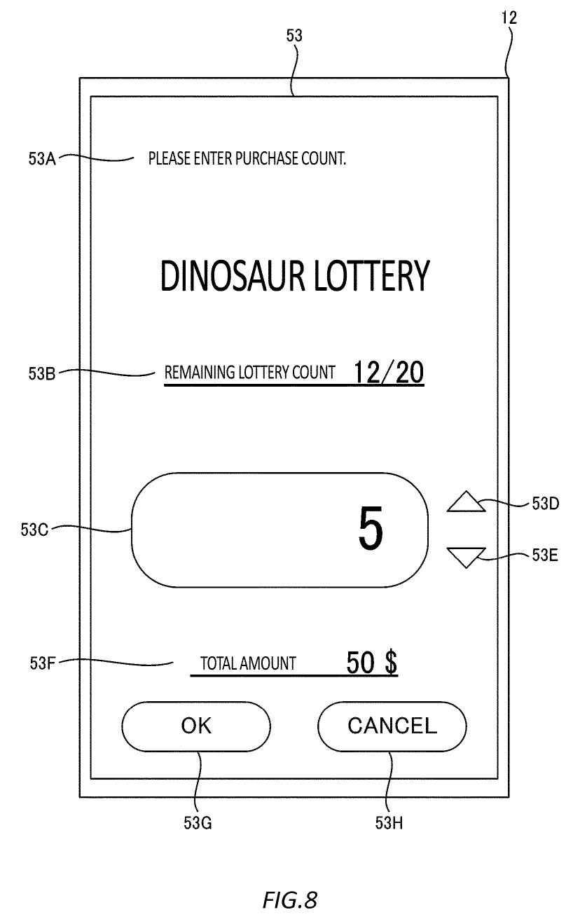

FIG. 8 is a diagram illustrating an example of a purchase count selection screen 53 displayed when the option 52A of "dinosaur lottery" is selected. An input message 53A prompting input of a purchase count of the dinosaur lotteries, such as "please enter purchase count”, is displayed on the purchase count selection screen 53. In addition, a "remaining lottery count" 53B indicating a remaining count of at least one lottery available for the dinosaur lottery is displayed on the purchase count selection screen 53. The display of "12/20" indicates that 12 times out of 20 times of lotteries prepared is remaining. In addition, an "input count" 53C indicating the purchase count (five times in this example) input by the user is displayed on the purchase count selection screen 53. The input count can be increased or decreased by operating an increase button 53D and a decrease button 53E. However, the purchase count (draw count) of the lottery in the series of ticket issuance procedures can be selected within a range of an upper limit of the selection count (for example, five times) preset for each product group. In addition, the purchase count of the lotteries can be limited by the remaining lottery count. For example, even if the upper limit of the purchase count is set to five times, the purchase count cannot be increased to the upper limit (five times) if the remaining lottery count is less than five. In addition, a "total amount" 53F indicating a price ($50 in this example) required for purchase is displayed on the purchase count selection screen 53. In addition, an "OK" button 53G for approving the displayed content and a "CANCEL" button 53H for canceling the displayed content are displayed on the purchase count selection screen 53.

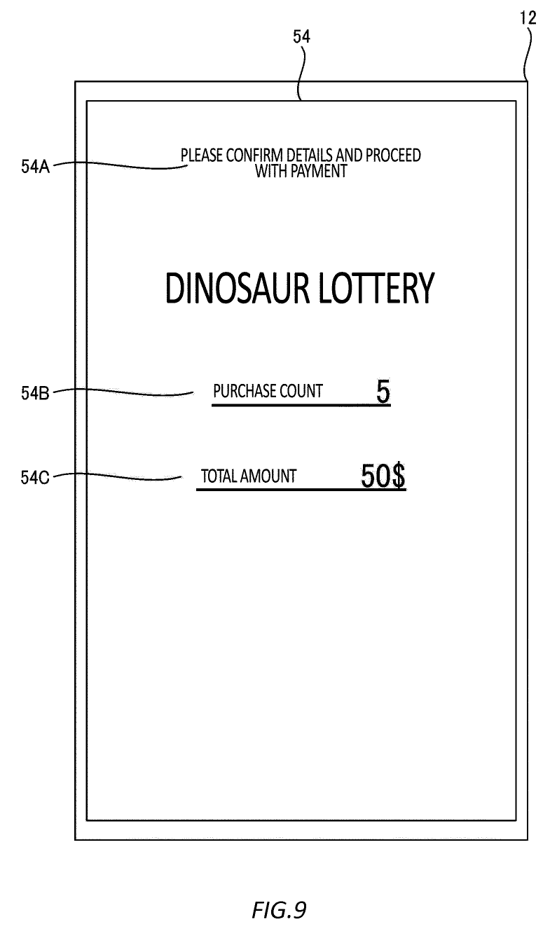

FIG. 9 is a diagram illustrating an example of the payment screen 54 displayed when the "OK" button 53G is tapped. A payment message 54A prompting payment for dinosaur lottery purchase, such as "please confirm details and proceed with payment”, is displayed on the payment screen 54. In addition, the payment screen 54 displays a "purchase count" 54B indicating the dinosaur lottery count (five times in this example) purchased by the user. In addition, a "total amount" 54C indicating the price ($50 in this example) of the purchased dinosaur lottery is displayed on the payment screen 54. When the payment screen 54 is displayed, the ticket issuing device 10 accepts touch payment by code input through the payment terminal 16, for example. In addition, the ticket issuing device 10 is configured to process payment according to a count of draws executed based on the lottery count purchased by the user.

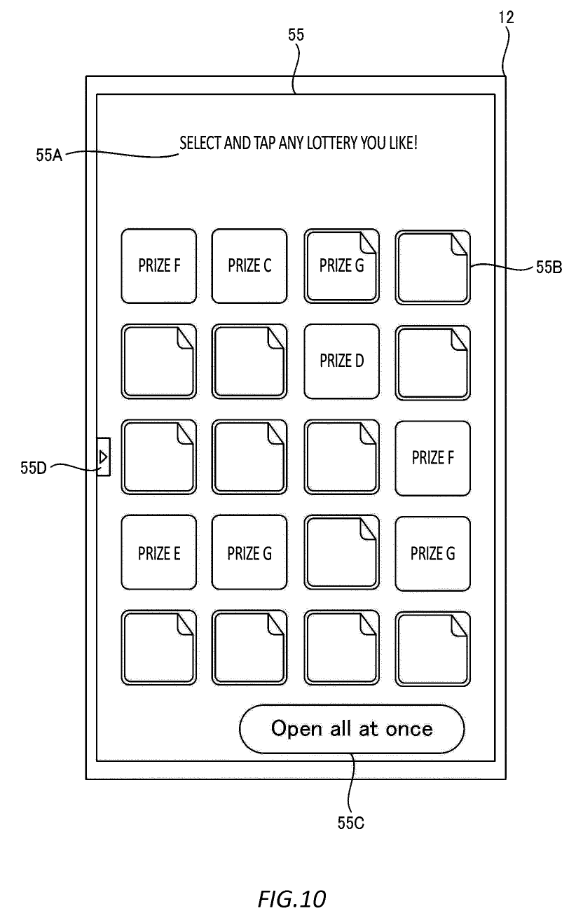

FIG. 10 is a diagram illustrating an example of the lottery screen 55 displayed when the payment for the purchased lottery is completed. A selection message 55A prompting lottery selection, such as "select and tap any lottery you like!", is displayed on the lottery screen 55. In addition, lottery options 55B (twenty options in this example) are displayed on the lottery screen 55. In addition, for the lottery option that has been selected by another person or oneself in this lottery, a corresponding lottery result is displayed. For example, in a case of this example, it is displayed that a total of eight options have been selected: one Prize C, one Prize D, one Prize E, two Prizes F, and three Prizes G. These selected options 55B are not selectable. Therefore, the user can select a lottery from twelve remaining lottery options 55B.

One lottery option 55B is associated with any of a plurality of products included in its character series. The ticket issuing device 10 selects, by drawing, any piece of product information included in the selected character series. In addition, on the lottery screen 55, an "Open all at once" button 55C is displayed which enables automatically selecting lotteries for the purchased count at once. When this button is tapped, automatic selection is performed randomly for a remaining purchase count of the lottery count purchased by the user. In addition, an item confirmation tab 55D for confirming an inventory product of a title (for example, "dinosaur lottery") performed by the user is displayed on the lottery screen 55. When the item confirmation tab 55D is tapped, for example, a list of products and inventory as illustrated in FIG. 6 is displayed on the lottery screen 55.

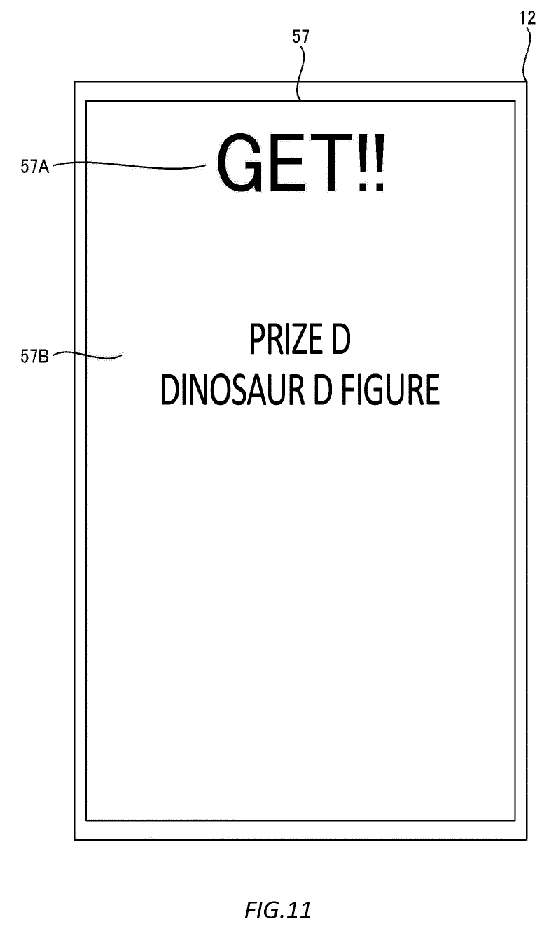

FIG. 11 is a diagram illustrating an example of an obtained product screen 57 displayed when the lottery option 55B is selected on the lottery screen 55 of FIG. 10. An obtainment message 57A for notifying that a product is obtained by lottery, such as "GET!!", is displayed on the obtained product screen 57. In addition, obtained product information 57B for notifying of the winning prize grade and product, such as a "Prize D, Dinosaur D figure", is displayed on the obtained product screen 57. Note that an image of the winning product (Dinosaur D figure) may be displayed on the obtained product screen 57 in addition to the prize grade and a product name.

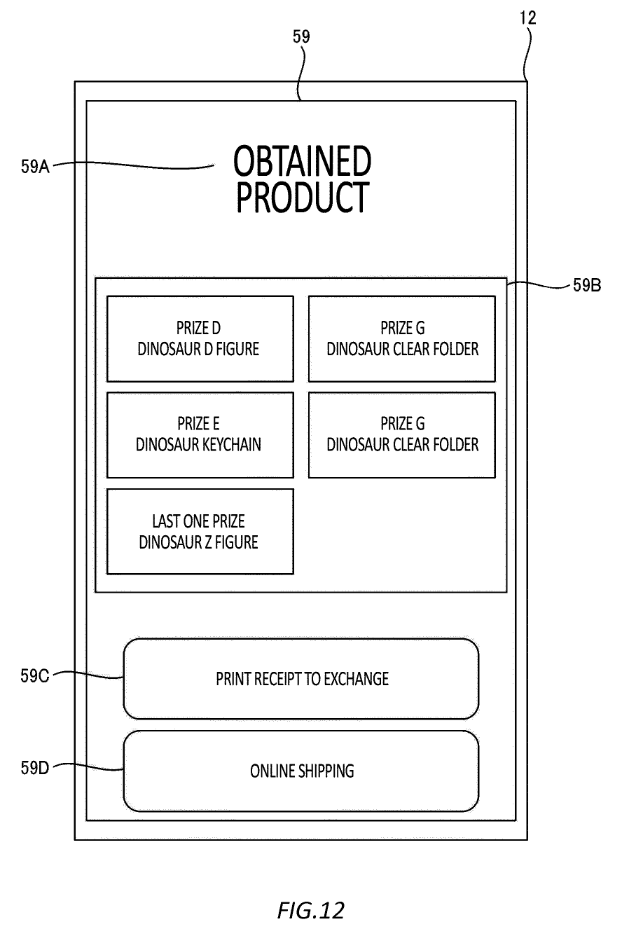

FIG. 12 is a diagram illustrating an example of the ticket output screen 59 displayed when lottery selection for the purchased count ends. An obtained product message 59A such as “obtained product” notifying that there is a product obtained by the user is displayed on the ticket output screen 59. The ticket output screen 59 includes a product display field 59B indicating a list of winning products. In the product display field 59B, for example, one "Prize D, Dinosaur D figure", one "Prize E, dinosaur keychain", two "Prize G, dinosaur clear folder", and one "last one prize, Dinosaur Z figure", which are the products obtained through lottery by the user, are displayed.

In addition, selection buttons 59C and 59D for selecting a method of receiving the obtained product are displayed on the ticket output screen 59. The selection button 59C is a button for selecting the exchange-receiving method for exchanging the printed ticket (receipt) with the product. The selection button 59D is a button for selecting the delivery-receiving method for receiving the product to be delivered via an online service. When the selection button 59C is tapped, a ticket (receipt) is printed from the thermal printer 13. In the ticket, for example, product information corresponding to each obtained product is displayed. When the selection button 59D is tapped, a two-dimensional code storing a URI for accessing an input page of a delivery destination is displayed on, for example, the ticket output screen 59. The user reads the two-dimensional code on the user terminal 40, and inputs an address of the delivery destination and the like.

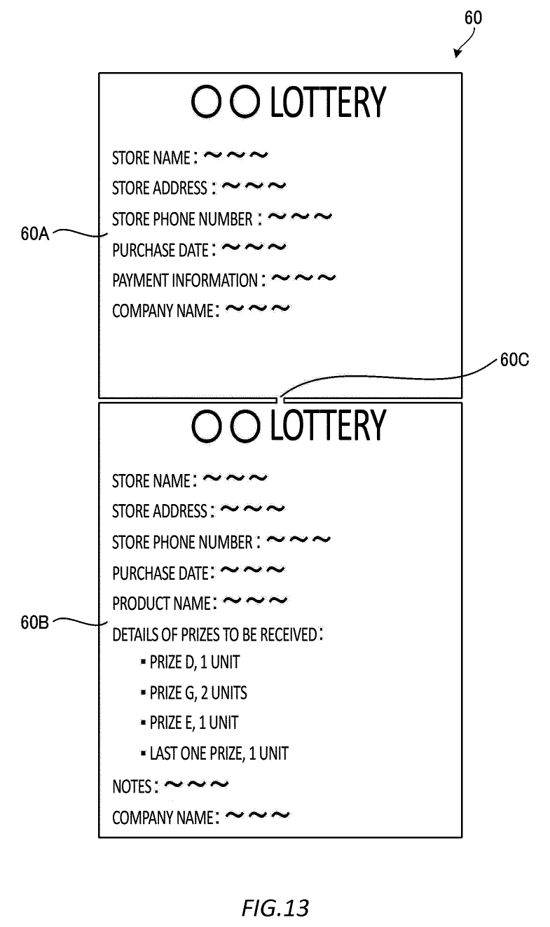

FIG. 13 is a diagram illustrating an example of a ticket 60 discharged from the thermal printer 13. The ticket 60 includes a receipt 60A and a voucher 60B. The receipt 60A and the voucher 60B can be separated by disconnecting a connecting portion 60C. "○○ lottery" indicating a product title, a store name, a store address, a store telephone number, a purchase date, payment information, a company name, and the like are displayed on the receipt 60A. A product title, a store name, a store address, a store telephone number, a purchase date, a product name, details of prizes to be received (Prize D, Prize G, Prize E, and last one prize), cautions, a company name, and the like are displayed on the voucher 60B.

Next, a case will be described in which the option of "○○ lottery" in which, for example, the "game method" is set is selected on the product selection screen 52 of FIG. 7. Even when the "game method" is selected, the screen transitions to the "purchase count selection screen 53", and when the "OK" button 53G is tapped on the purchase count selection screen 53, the screen transitions to the "payment screen 54". These steps are similar to a case where the "lottery method" is selected.

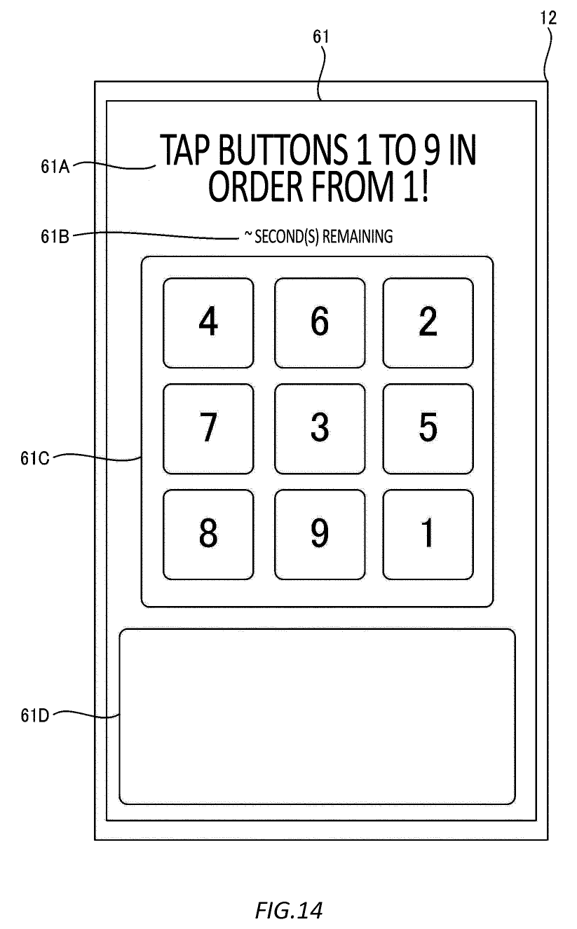

FIG. 14 is a diagram illustrating a count-up screen 61 which is an example of a game screen. A game operation message 61A for describing game content, such as "tap buttons 1 to 9 in order from 1!", is displayed on the count-up screen 61. In addition, a remaining time 61B indicating a time limit of a game, such as “~ second(s) remaining” is displayed on the count-up screen 61. The count-up screen 61 is provided with a game area 61C for performing a tap operation. In addition, the count-up screen 61 is provided with a product display field 61D that displays product information obtained in the game.

When the user clears a game, drawing is performed for the game every time the game is cleared, and any product is selected by the drawing. When a product is selected by the drawing, the screen transitions to the obtained product screen 57 illustrated in FIG. 11, for example, and information on the product obtained by the selection is displayed. When the purchased lottery count remains after one game ends, the screen transitions to a screen of a next game (another game of a different type). Then, when games for the purchase count end, the screen transitions to the ticket output screen 59 in FIG. 12.

When the "game method" is selected, it is possible to play games for a same count as a selected draw count. In addition, any game among a plurality of types of games prepared in advance is randomly selected and presented to the user. The games are configured such that a same type of game is not presented consecutively. The game illustrated in FIG. 14 is presented by being randomly selected from the plurality of types of games. As another game, for example, a memory game or the like may be used.

A time from when the "lottery method" for performing a lottery (draw) in FIG. 7 is selected to when the product information selected by the lottery in FIG. 11 is presented is defined as time T1, for example. A time from when the "game method" for playing a game is selected in FIG. 7 to when the product information selected by the drawing in FIG. 11 is presented is defined as time T2, for example. In this case, when time T1 and time T2 are compared, time T2 for a case where the game method is selected is longer than the time T1 for a case where the lottery method is selected, by an amount of time required for a game play operation by the user or by an amount of time for presentation effects.

As described above, the ticket issuing device 10 according to the present aspect can present a selected lottery ticket among a plurality of presented lottery tickets so as to visually recognize information regarding a prize grade and a product determined by drawing in accordance with the selection. Therefore, it is possible to allow the user who selects the lottery ticket thereafter to recognize what kind of product has been won so far. Accordingly, it is possible to provide a ticket issuing device with high entertainment value.

Note that a control method of the ticket issuing device described in the above-described embodiment can be implemented by executing a ticket issuing program prepared in advance on a computer. The present ticket issuing program is recorded in a computer readable storage medium and is executed by being read from the storage medium. In addition, the present ticket issuing program may be provided in a form stored in a non-transitory storage medium such as a flash memory, or may be provided via a network such as the Internet. The computer that executes the present ticket issuing program may be included in the ticket issuing device, may be included in electronic equipment such as a smartphone, a tablet terminal, or a personal computer that can communicate with the ticket issuing device, or may be included in a server device that can communicate with the ticket issuing device and the electronic equipment.

### EXPLANATION OF REFERENCES

1: ticket issuing system;
10: ticket issuing device;
10A: main body portion;
10B: door portion;
11: main board;
12: touch panel monitor;
13: thermal printer;
14: code scanner;
15: speaker;
16: payment terminal;
17: communication module;
18: seal;
19: power supply means;
20: network;
30: server;
31: processor;
32: memory;
33: communication interface;
39: bus;
40: user terminal;
51: list;
52: product selection screen;
52A, 52D, 52E, 55B: option;
52B: label;
52C: provision method;
52F, 52G: scroll button;
53: purchase count selection screen;
53A: input message;
53D: increase button;
53E: decrease button;
53G, 53H, 55C: button;
54: payment screen;
54A: payment message;
55: lottery screen;
55A: selection message;
55D item confirmation tab;
57: obtained product screen;
57A: obtainment message;
57B: obtained product information;
59: ticket output screen;
59A: obtained product message;
59B, 61D: product display field;
59C, 59D: selection button;
60: ticket;
60A: receipt;
60B: voucher;
60C: connecting portion;
61: count-up screen;
61A: game operation message;
61B: time;
61C: game area; and
T1, T2: time.

What is claimed is:

1. A ticket issuing device comprising:
a presentation unit which presents a plurality of lottery tickets;
an issuance unit which issues a ticket describing product information; and
a control unit which controls the presentation unit and the issuance unit, wherein
a selected lottery ticket and an unselected lottery ticket, among the lottery tickets which are presented, are able to be presented in a distinguishable manner.

2. The ticket issuing device according to claim 1, wherein
the selected lottery ticket includes product information which is visually recognizable, and
the unselected lottery ticket does not include product information which is visually recognizable.

3. The ticket issuing device according to claim 1, wherein
the selected lottery ticket includes prize grade information which is visually recognizable, and
the unselected lottery ticket does not include prize grade information which is visually recognizable.

4. The ticket issuing device according to claim 1, wherein
a lottery ticket selected by oneself and a lottery ticket selected by another person. among selected lottery tickets, each being the selected lottery ticket, are able to be presented in a distinguishable manner.

5. The ticket issuing device according to claim 1, wherein
all unselected lottery tickets, each being the unselected lottery ticket, among the plurality of lottery tickets are able to be presented in a visually recognizable manner with a same pattern.

6. The ticket issuing device according to claim 1, wherein
at least one of the product information or prize grade information corresponding to the lottery ticket is able to be presented on condition that the lottery ticket has been selected.

7. The ticket issuing device according to claim 1, wherein
the plurality of lottery tickets are able to be presented at fixed positions.

8. The ticket issuing device according to claim 7, wherein
the plurality of lottery tickets are able to be presented in a matrix form.

9. The ticket issuing device according to claim 1, further comprising
an acceptance unit which is capable of accepting payment of consideration, wherein
the acceptance unit is capable of accepting the payment of the consideration before selection of the lottery ticket.

10. The ticket issuing device according to claim 9, wherein
when the consideration for two or more lottery tickets among the plurality of lottery tickets is accepted, the two or more lottery tickets are selectable.

11. The ticket issuing device according to claim 1, wherein
the lottery ticket is randomly associated with any piece of prize grade information among a plurality of pieces of prize grade information.

12. The ticket issuing device according to claim 1, wherein
the lottery ticket is able to be selected on condition that a touch operation for a certain period of time or longer is performed on the lottery ticket which is presented.

13. The ticket issuing device according to claim 1, further comprising
a registration unit which registers product information, wherein
the issuance unit is capable of issuing the ticket describing prize grade information selected from the product information which is registered.

14. The ticket issuing device according to claim 1, wherein
any one character series selected from a plurality of character series is set in a product group, and
a plurality of pieces of prize grade information are included as the product information for each of the character series.

15. The ticket issuing device according to claim 1, wherein
the ticket, which is issued, is redeemable for a product.

16. The ticket issuing device according to claim 1, wherein
the ticket, which is issued, includes a voucher and a receipt.

17. The ticket issuing device according to claim 16, wherein
the ticket, which is issued, includes the voucher and the receipt in a separable manner.

18. The ticket issuing device according to claim 1, wherein
an operation of simultaneously selecting two or more lottery tickets among the plurality of lottery tickets is invalidated.

19. A non-transitory computer readable storage medium having stored thereon a ticket issuing program of a ticket issuing device including a presentation unit which presents a plurality of lottery tickets; and an issuance unit which issues a ticket describing product information, wherein the ticket issuing program causes a processor of the ticket issuing device to perform processing comprising
enabling a selected lottery ticket and an unselected lottery ticket, among the lottery tickets which are presented, to be presented in a distinguishable manner.

20. A ticket issuing system comprising:
the ticket issuing device according to claim 1; and
a management device which is capable of communicating with the ticket issuing device.
